(19) United States
(12) Patent Application Publication
(10) Pub. No.: US 2004/0267571 A1
(43) Pub. Date: Dec. 30, 2004

(54) Health care management and wellness recovery system and method

(76) Inventors: Lou A. Villa-Arce, Gurnee, IL (US); JoAnn M. Moore-Scurto, Schaumburg, IL (US)

Correspondence Address: William J. Hallihan, HALLIHAN INTELLECTUAL PROPERTY LAW, LTD., Suite 2080, 125 S. Wacker Drive, Chicago, IL, 60606, US

(21) Appl. No.: 10/832,057

(22) Filed: Apr. 26, 2004

Related U.S. Application Data
(60) Provisional application No. 60/465,361, filed on Apr. 25, 2003.

(51) Int. Cl. G06F 17/60

(52) U.S. Cl. 705/2; 600/300; 434/236

(57) ABSTRACT

A method for reducing the cost of health care involves assessing patients and determining which patients have psychosocial issues that can put the first patient at-risk of having a longer than normal recovery period. Additional services are provided to those patients for whom it has been determined as having psychosocial issues that can put them at-risk of having a longer than normal recovery period. In one form, the at-risk patient are provided with information to enable them to develop a personal plan for change that is geared to providing them with coping skills and a support mechanism to aid the at-risk patient in overcoming the psychosocial issues that can tend to prolong the recovery period.

### WRITTEN DESCRIPTION

This application claims benefit of U.S. provisional application 60/465,361 filed 25 Apr. 2003, which is incorporated herein by reference.

The following relates to systems and methods for health care management and/or wellness recovery systems, and particularly to such systems and methods that identify individuals that are more likely to take longer periods to recover in an effort to provide additional assistance in order to shorten the recovery period for the identified individuals. This has particular application to such systems and methods that use a brief screening form that is filled out by the patient at the point of initial patient contact (such as the doctor's office or an emergency room) to identify patients that are more likely to take longer periods of time to recover and creating an individualized action plan for the patient to follow in an effort to minimize recovery time.

Health care costs have risen dramatically over time and have often outpaced the rate of inflation, even though efforts have been made to manage costs during this time period. In some cases, it is difficult to manage costs because the cost of health care, itself, is only one component of the total costs. For example, worker's compensation costs can pose a particular problem because workers compensation is a multidimensional problem. The traditional approach of discounting medical care has failed to make significant reductions because workers compensation costs have a large component that is not a medical condition.

The primary reason price controls for medical expenses have failed as a strategy to control costs of workers compensation is due to the distribution of other costs. Medical costs represent approximately 35 percent of workers compensation costs. The other 65 percent of costs come from administrative, short-term employee disability payments, and long-term employee disability payments. Since 65 percent of the costs are not affected by medical care price control, significant cost reductions have been difficult to obtain. Traditional thinking is that the 65 percent of non-medical costs cannot be controlled and is just the cost of doing business. Therefore, prior systems that ignored the 65 percent of non-medical costs limited any potential to significantly reduce workmen's compensation costs because they only sought to lower the costs of each medical procedure.

Other forms of health care can also be difficult to achieve significant cost reductions because they typically seek to lower the costs of each medical procedure and do not spend much effort at trying to reduce the number of occurrences that medical procedures are performed. According to established research, 20 percent of all patients drive 80 percent of the costs. Research further demonstrates that the primary cause for prolonged utilization of medical and disability payments is directly attributable to psychosocial issues (for our purposes when we use the term psychosocial issues, in the specification, we also mean to include psychophysiology). Indeed, for the group of patients whose disability exceeds 90 days, the average time for disability exceeds 2 years for individuals that are 25, 35, 45, or even 55 years old.

The inventors have discovered, the potential to significantly reduce health care costs can be realized by the early identification of the 20 percent of patients that drive 80 percent of the costs and addressing the psychosocial issues that tend to prolong the recovery time of these patients. This process has been found to reduce the recovery time for many of the identified patients, thereby reducing the medical costs for procedures and tests that would often be performed if the recovery period is prolonged. Quickly identifying those patients who have psychosocial issues that may prolong the recovery period and spending a limited amount of time and followup with this group of patients significantly, reduces the overall recovery time and medical costs for such patients. Therefore, a need exists for a simple and easy-to-use system for the early identification of patients that may experience prolonged recovery times because of psychosocial issues the patient is experiencing.

### SUMMARY

The disclosed health care management and wellness recovery system and method comprises certain novel features and a combination of parts herein after fully described, illustrated in the accompanying drawings, and particularly pointed out in the appended claims, if any, it being understood that various changes in the details may be made without departing from the spirit, or sacrificing any of the advantages of the disclosed health care management and wellness recovery system and method.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a flowchart of a primary treatment cycle of the invention;

FIG. 2 is a flowchart of a secondary treatment cycle of the invention;

FIG. 3 is a schematic diagram of another primary and secondary treatment cycle of the invention; and

FIG. 4 is one example of a form medical inhibitors inventory of the invention.

### DETAILED DESCRIPTION

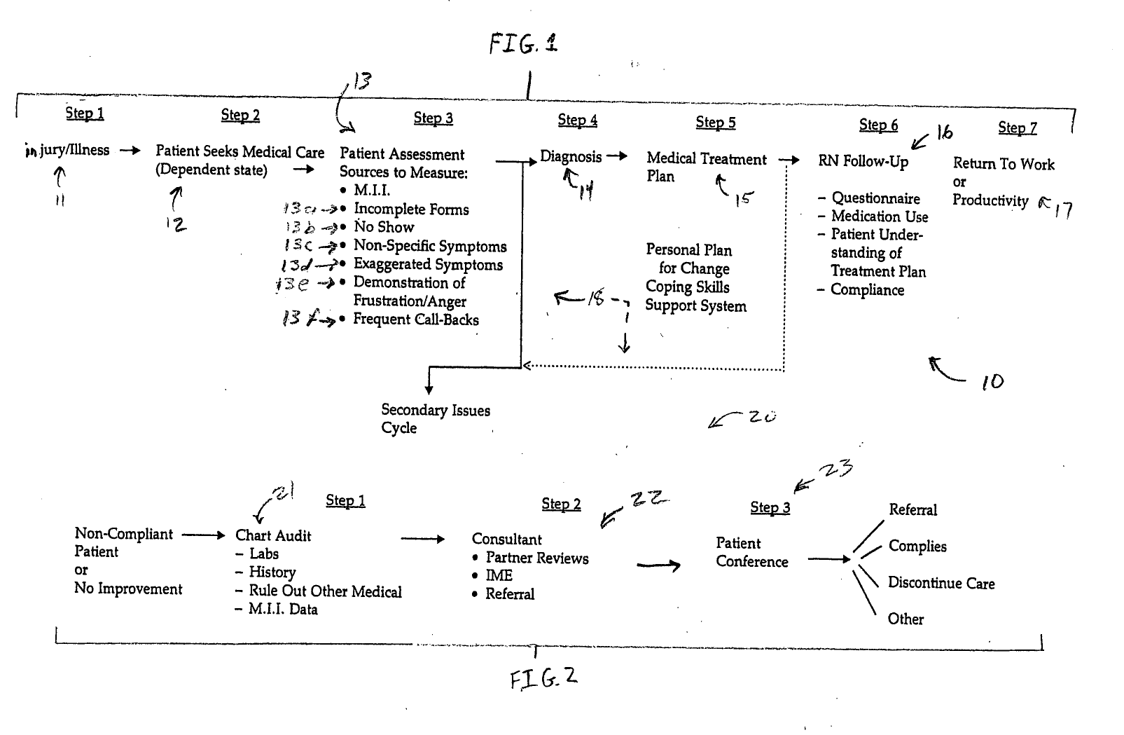

Referring to FIGS. 1 and 2 there is illustrated one form of a primary and a secondary treatment cycle that is designed for the early identification of those patients that have psychosocial issues that may interfere with recovery. These cycles are also designed for providing an early intervention in an attempt to treat or alleviate those psychosocial issues that tend to contribute to a prolonged recovery time. In one form, a primary treatment cycle 10 is used to treat a patient. One example of primary treatment cycle 10 is shown in FIG. 1 and starts when a patient believes they have experience a medical condition, such as an injury or illness at 11. At some time after realizing that there is a medical condition, the patient gets to a dependent state and seeks medical care at 12. For example, the patient may seek medical care at 12 by going to a primary care physician's office, an acute care clinic, or an emergency room.

During the time period that the patient seeks or receives medical care, and preferably early on during the time period that the patient seeks or receives treatment, an assessment is made at of the patient to determine whether there are any factors that indicate that the patient has psychosocial issues that can tend to prolong the recovery period. As a shorthand form, patients identified as having sufficient psychosocial issues that can tend to prolong the recovery period are referred to as “at risk patients.” In one form, this assessment 13 is made before any treatment of the patient's medical condition and may even occur before the diagnosis of the patient's medical condition. For example, the patient assessment can be made during the patient's first visit seeking medical care. In one form, the patient provides information that is used for the patient assessment before the patient first sees a doctor, a nurse practitioner, or other health care giver during the patient's first visit seeking medical care for the patient's current condition.

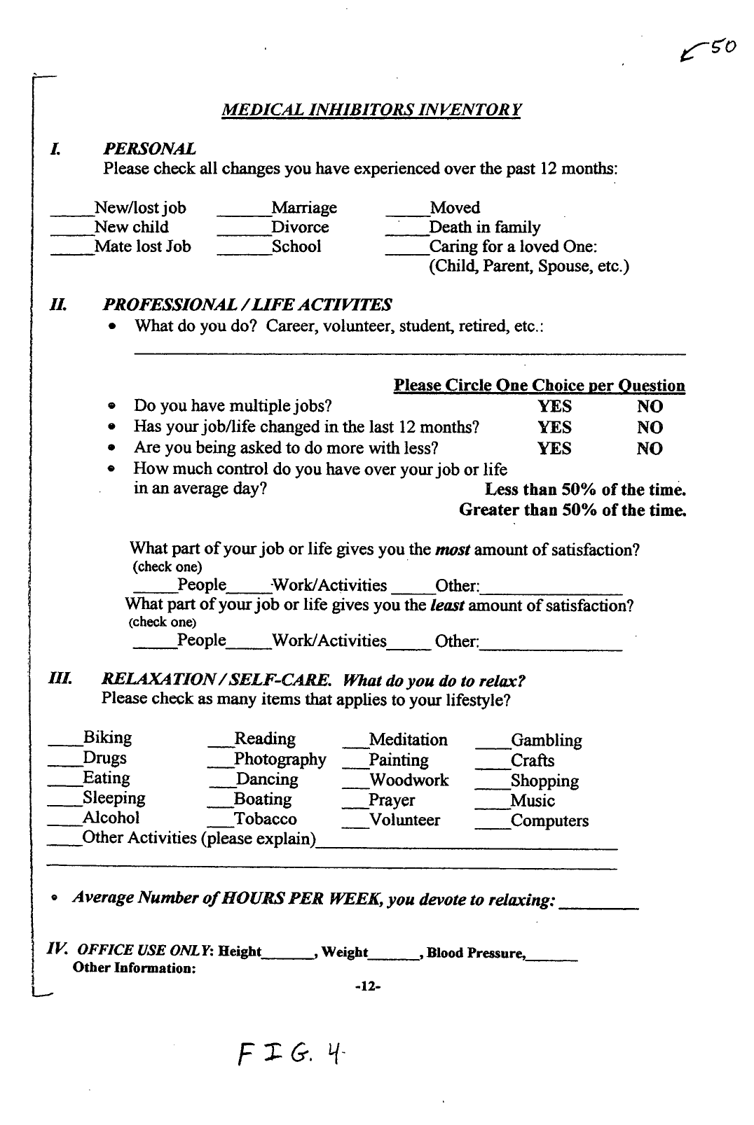

A variety of sources for information can be used to make patient assessment 13, and it should be noted that the assessment can be revised at a later date. Examples of the sources and information that can be used to make patient assessment 13, include any information the patient provides on the patient's medical inhibitor's inventory form 40 (which is discussed in further detail, later, with respect to FIG. 4). The failure of the patient to complete 13a the medical inhibitor's inventory form 40 can be an indication that the patient may be experiencing psychosocial issues that may tend to prolong recovery. Making appointments that they do not show up for 13b can be another indicator. The patient stating non-specific symptoms 13c or stating exaggerated symptoms 13d can be another indicator. Demonstrations of frustration or anger 13e at the prolong recovery period can also be an indicator, as can frequent call backs 13f by the patient. Further details concerning how patient assessment 13 is made, is discussed later with respect to FIG. 4.

At some time after the patient seeks medical care 12, a health care giver makes a diagnosis 14 of the condition 11 for which the patient sought treatment 12. After diagnosis 14, a medical treatment plan 15 is decided upon and begun. If at any point after seeking medical care 12 and before the end of medical treatment plan 15, or before any return to work or productivity 17, a health care giver makes a patient assessment 13 that determines the patient is an at risk patient, then the at risk patient is provided with information to enable them to develop a personal plan for change 18 that is geared to providing coping skills and a support mechanism that will better enable the at risk patient to overcome the psychosocial issues that may prolong recovery. In one form, patient assessment 13 is made before diagnosis 14. However, patient assessment 13 can also be made during the course of undergoing medical treatment plan 15 or any time prior to returning to work or productivity 17. In any event, in order to provide substantial benefit the patient assessment 13 needs to be made before the patient has recovered. Further details concerning personal plan for development 18 is discussed later.

In one form, a health care giver, such as an registered nurse (RN), will follow up 16 with the at risk patient in order to determine a variety of things, such as whether the at risk patient: (a) is following medical treatment plan 15; (b) understands medical treatment plan 15; (c) is following proper medication usage; and/or (d) is complying with the personal plan for change. In one form, the health care giver can utilize a questionnaire that includes questions concerning various aspects of the at risk patient's personal plan for change 18 and medical treatment plan 15 in order to determine whether the at risk patient is following all portions of each. If the at risk patient is not following all portions, the health care giver can discuss the patient's medical condition, elicit the patient's desire and willingness to recover from the medical condition, discuss the importance of the personal plan for change to the recovery process, elicit the patient's cooperation and desire to follow the personal plan for change in order to shorten the recovery time. Subsequent follow ups 15 can be performed, if needed or otherwise desired.

Eventually, the patient recovers and returns to work or productivity 17. On occasion, the patient shows little improvement over a period of time. If no improvement, little improvement, or less than the expected improvement in the patient's condition is experienced during a particular period (such as two, three or four weeks, or within 90 days), then the medical care giver may need to reassess a patient (that was not previously identified as an at risk patient) in order to determine whether the patient assessment 13 indicates that the patient may be an at risk patient. Additionally, the medical care giver should make a determination as to whether or not an at risk patient (or other type of patient) has complied with the medical treatment plan 15 and, if appropriate, personal plan for change 18. If no improvement is shown in a certain time period, such as within two, three, or four weeks or within 90 days, or the patient has been non-compliant, the medical care giver begins the patient in a secondary cycle 20.

The medical care giver places a non-compliant patient or a patient that has not shown improvement in a secondary treatment cycle in order to determine how best to treat the patient. The medical care giver should perform a chart audit 21 to determine why the patient is not showing the expected improvement in the time period. Any labs should be reviewed along with the patients medical history and systems. Additional tests may need to be performed in order to rule out other medical diagnosis. The medical inhibitors inventory, along with other factors, should also be reviewed in order to determine if the patient should be moved to the at risk patient category for appropriate action, described previously.

If the medical care giver has ruled out other medical diagnosis, then the medical care giver should work with another medical care giver as a consultant 22, or referral, on the case. At this stage, another medical care giver reviews the diagnosis and medical treatment plans, along with the chart audit to provide a second opinion. An independent medical examination (IME) may be performed to determine whether the patient may be abusing the insurance decision. If no additional medical diagnosis is likely, the medical care giver has a patient conference 23 to discuss and explain the issue with the patient. If the patient has been non-compliant with the treatment program, its importance and the patient's desire to recover are discussed. If the patient is not compliant and the medical inhibitors inventory indicates that referral to a drug or alcohol program is appropriate, such referral is made. If it noncompliance is due to psychiatric problems, a psychiatric referral is made. If the patient indicates a willingness to comply with the treatment program, the patient is allotted additional time to comply. In this case, additional follow up 16 may be needed. The medical care giver might also determine that the patient is abusing the insurance system, in such case, care is discontinued. The medical care giver may also determine that some other action is appropriate.

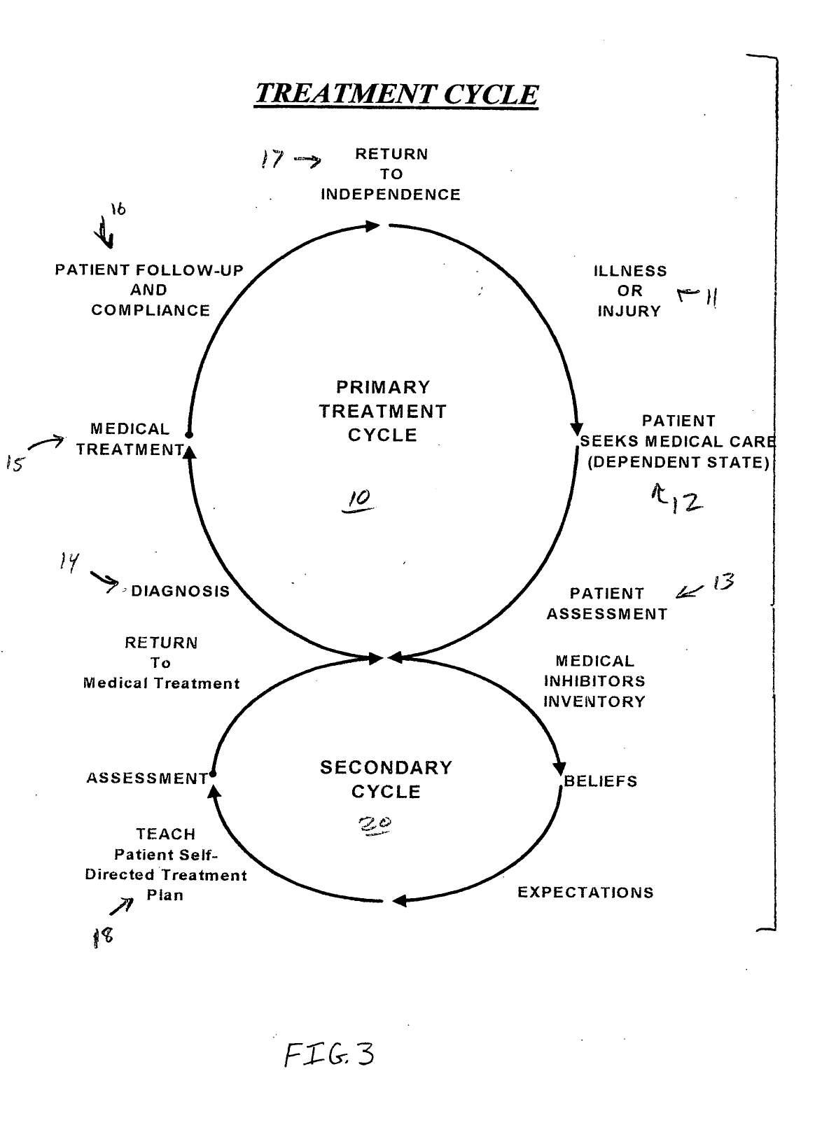

Referring to FIG. 3, the patient's treatment program can also be viewed as a primary treatment cycle 30 that involves medical treatment that evolves into, or interacts with, a secondary cycle 40 that involves the patient assessment 13 and treatment for any psychosocial issues that may prolong recovery. Secondary cycle 40 should take into account the patients beliefs, anxieties and expectations regarding their condition.

Referring to FIG. 4, one example of a medical inhibitors inventory (MII) form 50 is shown that is used to collect information that may be used to make patient assessment 13. In one form, MII form 50 is divided into multiple sections, with at least some of the sections being geared to providing information that is used to make patient assessment 13. Normally, the patient will complete MII form 50, except for any sections that are for office use. In a preferred form, the patient completes MII form 50 at the point of initial contact when they seek medical attention, such as a doctor's office or emergency room.

Some of the information, in MII form 50, is geared to discover personal stressful experiences that an individual has experienced over a certain time frame, such as the last 3, 6, 9, 12, 18 or 24 months. The patient is asked to identify if any of these items or collection of items are significant to the patient's perspective towards life. For example, such experiences may include having a new job, losing a job, marriage, residential move, a new child, divorce, death in family (immediate, extended, or a person otherwise considered to be a member of the family), caring for a loved one (such as an ill or dying child, parent, spouse, etc.), loss of job by mate or other financial contributor, and attending school or transferring schools. No one change is necessarily more important than the other.

Additional information may be geared towards finding out various stressful experiences that may be ongoing. Such stressful experiences may include professional activities or other life activities. This also can provide information concerning how the patient spends their days, the amount of control the perceive they have over their job or life and identifies the activities that provide them with satisfaction and dissatisfaction. Information concerning the career, volunteer, student, or retirement activities that the patient does can be helpful in identifying stress. Additionally, true/false, yes/no or other multiple choice (or even fill in the blank) questions can be provided concerning other possible stresses in the patient's life. For example, whether the patient (or their mate) has multiple jobs, had a job or life change in a certain time period, such as 3, 6, 9, 12, 18 or 24 months. Another stress may be if the patient is being asked (at work, home or otherwise) to do more with less.

Other questions may be used to determine the patient's locus of control, such as a question concerning how much control the patient has over their job and/or life. Additional information may be gleaned from determining what part of the patient's job and/or life gives them the most amount of satisfaction and the least amount of satisfaction.

A third section may be provided to determine how the patient relaxes or otherwise provides self-care for the stresses in there life. For example, the patient might be asked to explain what they do to relax. The patient may also be check off which activities, such as those shown in section III of the form in FIG. 4, that they use to relax. The third section allows the health care giver to determine whether the patient's current relaxation techniques are positive techniques that will tend to help recovery, or are negative techniques that may hinder recovery or that are contributing factors for current or future medical conditions.

If the patient identifies three or more stresses (such as those in sections I and II of FIG. 4), the patient is at risk because such stresses tend to reduce a patient's internal motivation. However, having three or more stresses does not guarantee that the patient will have a prolonged recovery period if they do not get additional attention and make and follow a personal plan for change.

A fourth section, such as section IV in FIG. 4, can be provide for office use to compare the patient's responses regarding their lifestyle to their medical condition. This provides the health care giver, on subsequent visits, with another baseline of information to quantify medical improvement and patient responsibility for their health and compliance with their personal plan for change.

In one form, the MII form 50 is short and may even be a single page in order to allow the medical care giver to quickly and effectively identify key aspects of the patient's life that could be contributing factors regarding the reason for their medical condition or a factor in delaying their medical recovery. By being a short form, MII form 50 can be quickly assessed by the health care giver by glancing at the form for three stress factors without the need for any computerized analysis of the answers. Additionally, the same MII form 50 can be used for patients that have different types of medical conditions. In other words, the same form can often be used regardless of the medical condition of the patient and there is no need for different forms for different medical conditions.

If the patient is determined to be at risk, the health care giver needs to acknowledge and ask how the patient is managing all of these issues with their current medical problems. In order to achieve optimal results, the medical care giver needs to acknowledge the patient's stress, control/satisfaction in their life and their coping techniques without passing judgment or making value statements to the patient unless any activity is a contributing factor for the patient's medical condition or a factor in recovery. Instead, the medical care giver should assume the role of facilitator and use reflective techniques to help the patient become aware of how their lifestyle and stress contributes to their overall health.

The majority of all patients fall into one of the following categories: (1) medical condition is cause or exacerbated due to stress and ineffective self-care techniques; (p2) after acknowledging the stress, the patient provides additional details about the circumstances of the stress and the patient is receptive to change; or (3) the patient is angry, confrontational and highly emotional or has a low affect and is not receptive to change. Regardless of the response, the health care giver needs to ask if the patient's stress management program is effective. Regardless of the response to the previous query, the health care giver should provide information to allow the patient to create a self-directed treatment plan, such as personal plan for change 18.

Such process will also help determine if the patient is able to, or receptive to, change. In one form, the health care giver provides an overview of the self-directed treatment plan while explaining how the patient's various issues are contributing to their condition, or prolonging their condition, and how they have the power to regain control over their lives and reduce the recovery time and increase their health.

The patient's self-directed treatment plan can be a short form or brochure that provides the patient with the opportunity for self-reflection. It should aid the patient in identifying the important things in their lives and the amount of time they devote to them. After the patient sees the discrepancies, it is easier for them to view the plan as a key for changing their lifestyle and aiding their recovery. The brochure should point out how the patients environment places various stresses upon them which often cause certain behaviors that can affect the patient's health or recovery time. By realizing the importance that a patient places on various activities and the corresponding amount of time they place on such activities allows the patient to reprioritize their activities to more closely align the time and importance of the various activities.

One version of the patient's self-directed treatment plan or personal plan for change 15 is shown on pages 13, 14, and 15

### OVERVIEW

This guide was developed to assist you during your medical treatment and or recovery period. As your treating physician, I am committed to your medical and emotional well being.

I assure you that I will provide you with the finest medical services available to me. Your recovery is also dependent on your active participation.

Participation means adhering to your treatment plan, taking your medications according to the prescribed schedule and making all follow-up appointments. Through this process we can reasonably expect a complete medical recovery.

Research indicates stress is a significant contributing factor in causing various medical disorders and can inhibit recovery. This brochure was developed to help identify your life stresses that may delay your recovery.

My objective is to assist you with identifying important values in your life, so that you can manage the stresses that prohibit you from achieving the quality of life you deserve and desire! If you would like to review your plan with me, or any member of our medical team, please do not hesitate in contacting us.

[image]

[image]

[image]

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

We claim:

1. A method for reducing the cost of health care comprising:
assessing a first patient and determining whether the first patient has psychosocial issues that can put the first patient at-risk of having a longer than normal recovery period;
assessing an nth patient and determining whether the nth patient has psychosocial issues that can tend to prolong the recovery period;
providing additional services to any of the first through nth patients for whom it has been determined as having psychosocial issues that can put the nth patient at-risk of having a longer than normal recovery period.

2. The method according to claim 1 wherein providing additional services includes providing the at-risk patient with information to enable the at-risk patient to develop a personal plan for change that is geared to providing coping skills and a support mechanism to aid the at-risk patient in overcoming the psychosocial issues that can tend to prolong the recovery period.
